(19) United States
(12) Patent Application Publication
(10) Pub. No.: US 2011/0231000 A1
(43) Pub. Date: Sep. 22, 2011

(54) POWER MONITORING DEVICE, POWER MONITORING METHOD, AND DEVICE FOR MOUNTING COMPONENT

(75) Inventors: Syunsuke Higashi, Yamanashi (JP); Nobuyoshi Kobayashi, Osaka (JP); Yasuyuki Nishihara, Yamanashi (JP); Masaya Matsumoto, Yamanashi (JP)

(73) Assignee: PANASONIC CORPORATION, Osaka (JP)

(21) Appl. No.: 13/131,755

(22) PCT Filed: Oct. 23, 2009
(86) PCT No.: PCT/JP2009/005615

§ 371 Date: May 27, 2011

(30) Foreign Application Priority Data
Nov. 28, 2008 (JP) 2008-303969

(51) Int. Cl. G06F 1/28; G06F 19/00

(52) U.S. Cl. 700/105; 700/108

(57) ABSTRACT

A power monitoring device is configured to monitor power consumed in a device for mounting component, which constitutes a component mounting line. The power monitoring device includes: an operation information collecting section configured to collect in time-series operation information representing a device operation state of the device for mounting component and to create time-series data of the operation information; a power measuring section configured to measure in time-series an amount of power consumption representing an amount of power consumed in the device for mounting component and to create time-series data of the amount of power; a synchronous output section configured to output the time-series data of the operation information and the time-series data of the amount of power by synchronizing respective time axes in time-series with each other.

### TECHNICAL FIELD

The present invention relates to a power monitoring device, which monitors an amount of power consumed in a device for mounting component used in a component mounting line configured to mount a component on a board and to manufacture a mounting board, a power monitoring method, and a device for mounting component incorporating a power monitoring device therein.

### BACKGROUND ART

A component mounting line configured to mount a component on a board and manufactures a mounting board includes various devices configured to mount component, such as a screen printing device, a component mounting device, and a reflow device. These devices for mounting component operate by using power, and include an actuating section which consumes power and executes a predetermined function, such as a board conveying mechanism using an electric motor as a driving source, a movable mechanism such as a component mounting mechanism, and a heating mechanism configured to heat a board by using an electric heater.

From the viewpoint of recent global environment protection, it is required to suppress an amount of used power in a production field such as that of a component mounting line. Therefore, up until now, an amount of power used by a individual production facility has been measured and an amount of power consumption has been monitored with the passage of time (see Patent Document 1). In a related art technique disclosed in the Patent Document, a set amount of power serving as a reference of the amount of power consumed by the individual facility in a predetermined period is registered in advance, and a result obtained by measuring an actual amount of power consumption in the predetermined period is displayed together with the set amount of power.

### RELATED ART DOCUMENTS

### Patent Documents

Patent Document 1: JP-A-2006-277131

### SUMMARY OF THE INVENTION

### Problem to be Solved by the Invention

However, in the above-described related art technique, from the viewpoint of effective utilization of the obtained information, there is a problem as follows. Specifically, in the related art technique, it is possible to determine whether the amount of power consumption is within the set amount of power, but in a case where the amount of power consumption exceeds the set amount of power, it is impossible to analyze the reason why the amount of power consumption is increased and therefore it is difficult to utilize the monitoring result as effective information for decreasing the amount of power consumption.

An object of the invention is to provide a power monitoring device, a power monitoring method, and a device for mounting component, which are capable of utilizing a power monitoring result as effective information for decreasing an amount of power consumption.

### Means for Solving the Problem

A power monitoring device of the present invention is configured to monitor power consumed in a device for mounting component, which constitutes a component mounting line, and the power monitoring device includes: an operation information collecting section configured to collect in time-series operation information representing a device operation state of the device for mounting component and to create time-series data of the operation information; a power measuring section configured to measure in time-series an amount of power consumption representing an amount of power consumed in the device for mounting component and to create time-series data of the amount of power; and a synchronous output section configured to output the time-series data of the operation information and the time-series data of the amount of power by synchronizing respective time axes in time-series with each other.

A power monitoring method of the present invention is for monitoring power consumed in a device for mounting component, which constitutes a component mounting line, and the power monitoring method includes: an operation information collecting process of collecting in time-series operation information representing a device operation state of the device for mounting component and creating time-series data of operation information; a power measuring process of measuring in time-series an amount of power consumption representing an amount of power consumed in the device for mounting component and creating time-series data of an amount of power; and a synchronous output process of outputting the time-series data of the operation information and the time-series data of the amount of power by synchronizing respective time axes in time-series with each other.

A device for mounting component of the invention constitutes a component mounting line configured to mount a component on a board and to manufacture a mounting board, and the device for mounting component includes: an element actuating section configured to operate by consuming power in the device for mounting component; and a power monitoring device according to any one of claims 1 to 7.

### Advantages of the Invention

According to the invention, time-series data of operation information created by collecting in time-series operation information representing a device operation state of the device for mounting component, and time-series data of amount of power created by measuring in time-series an amount of power consumption representing an amount of power consumed in the device for mounting component are output as operation power consumption data by synchronizing respective time axes in time-series with each other, whereby it is possible to utilize a power monitoring result as effective information for decreasing an amount of power consumption.

### BRIEF DESCRIPTION OF THE DRAWINGS

FIG. 1 is an explanation diagram illustrating a configuration of a component mounting system of an embodiment 1 of the invention.

FIG. 2 is a block diagram illustrating a configuration of a device for mounting component of the embodiment 1 of the invention.

FIG. 3 is a block diagram illustrating a configuration of a power monitoring process unit in the device for mounting component of the embodiment 1 of the invention.

FIG. 4 is an explanatory diagram illustrating a data configuration of operation information output from the power monitoring process unit of the embodiment 1 of the invention.

FIG. 5 is an explanatory diagram illustrating a data configuration of operation information output from the power monitoring process unit of the embodiment 1 of the invention.

FIGS. 6(a) and 6(b) are explanatory diagrams illustrating an output example of the operation information output from the power monitoring process unit of the embodiment 1 of the invention.

FIGS. 7(a) and 7(b) are explanatory diagrams illustrating an output example of the operation information output from the power monitoring process unit of the embodiment 1 of the invention.

FIG. 8 is a process flow diagram illustrating a power monitoring method of the embodiment 1 of the invention.

FIGS. 9(a) to 9(c) are explanatory diagrams illustrating a display example of operation power consumption data output from the power monitoring process unit of the embodiment 1 of the invention.

FIG. 10 is an explanatory diagram illustrating a display example of operation power consumption data output from the power monitoring process unit of the embodiment 1 of the invention.

FIGS. 11(a) and 11(b) are explanatory diagrams illustrating a display example of operation power consumption data output from the power monitoring process unit of the embodiment 1 of the invention.

FIG. 12 is an explanatory diagram illustrating a configuration of a component mounting system of the embodiment 1 of the invention.

FIG. 13 is a block diagram illustrating a configuration of a power monitoring process unit in a device for mounting component of an embodiment 2 of the invention.

FIG. 14 is a flow chart illustrating the sequence of adjustment for decreasing an output of an element actuating section, which is the largest source of power consumption at the peak time of power consumption, in regard to a transition graph of the power consumption in FIG. 10.

FIGS. 15(a) and 15(b) are diagrams illustrating a specific example of determination at ST14 of FIG. 14.

FIG. 16 is a flow chart illustrating the sequence of adjustment for decreasing an output of an element actuating section in a working process where the power consumption becomes the largest, in regard to a graph illustrating a ratio of power consumption for each working process in FIG. 11.

### MODE FOR CARRYING OUT THE INVENTION

### Embodiment 1

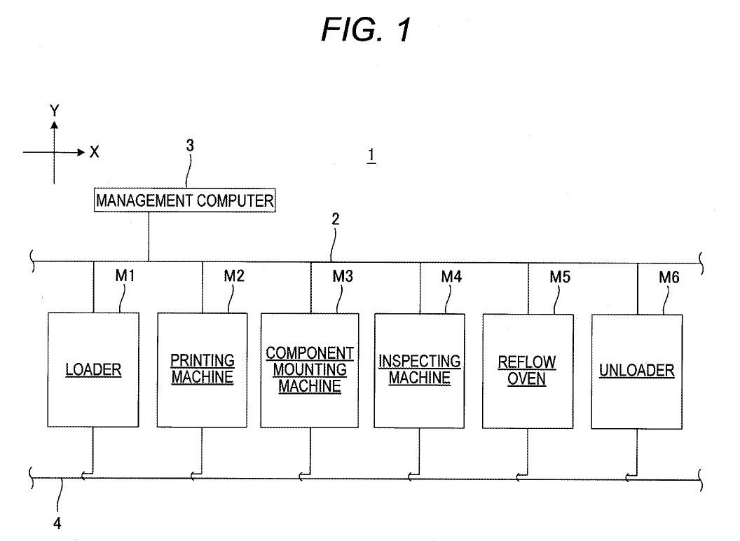

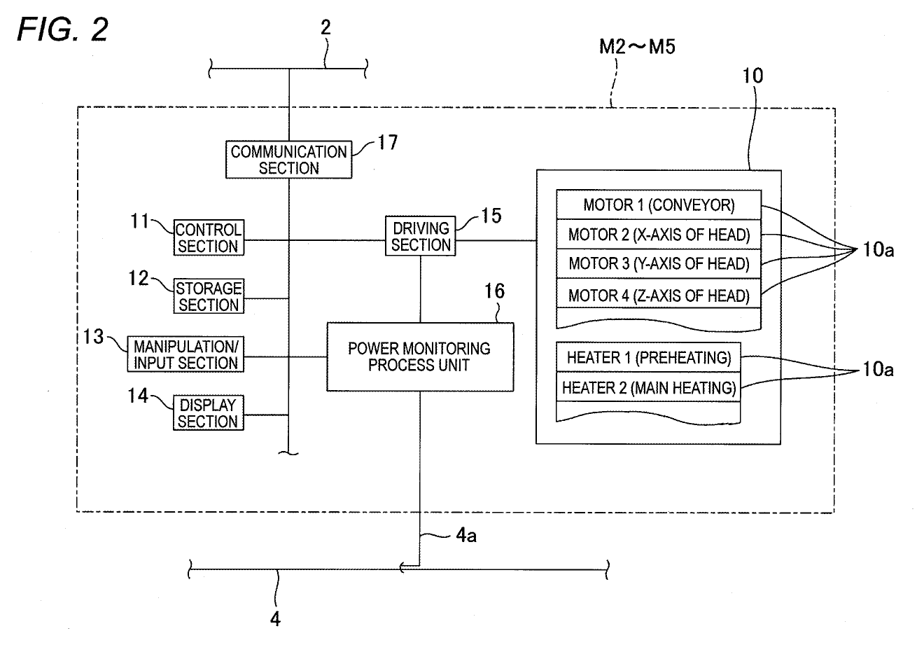

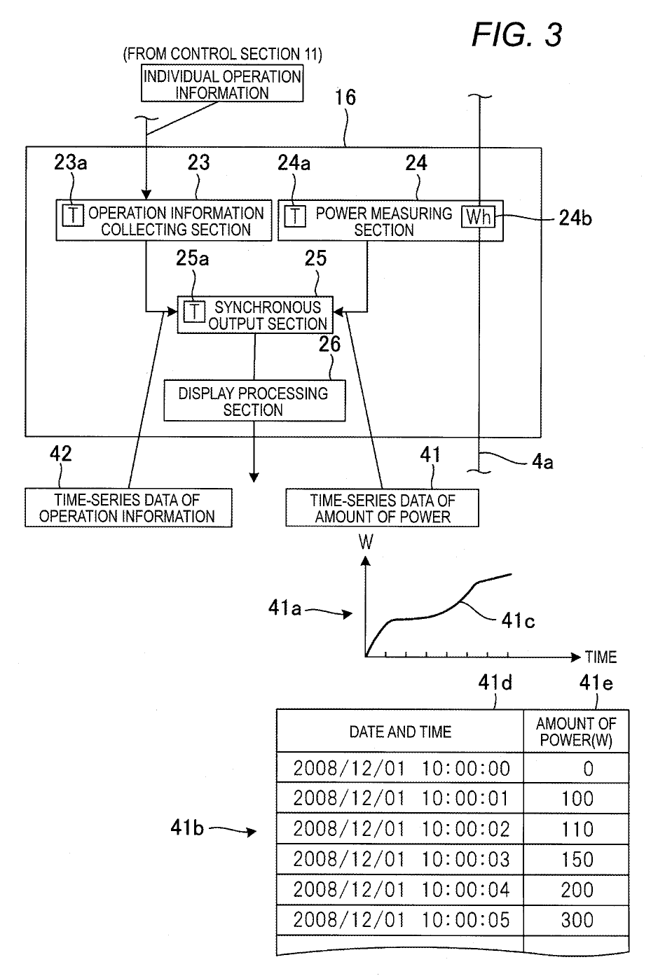

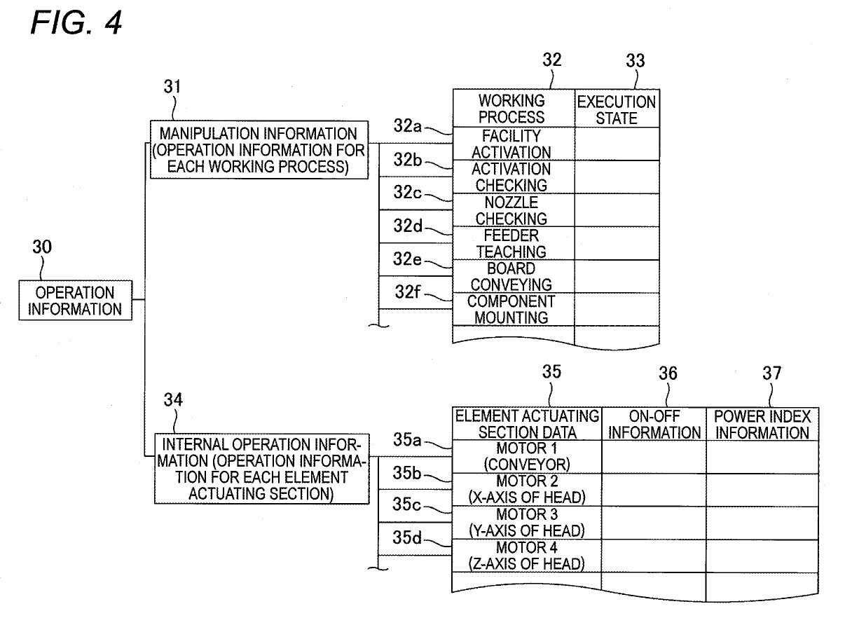

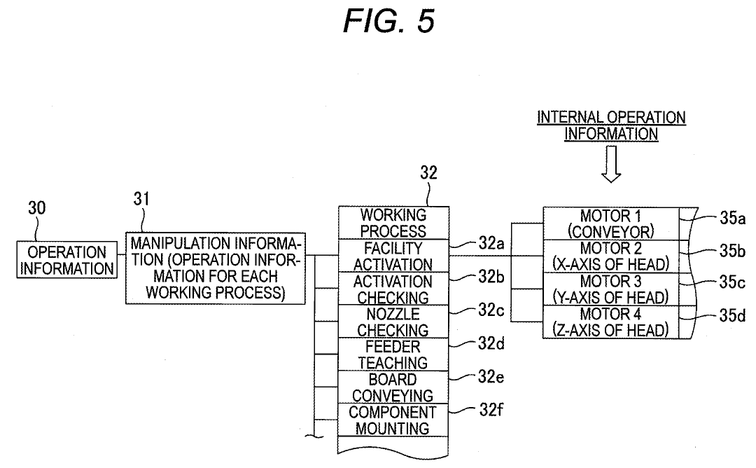

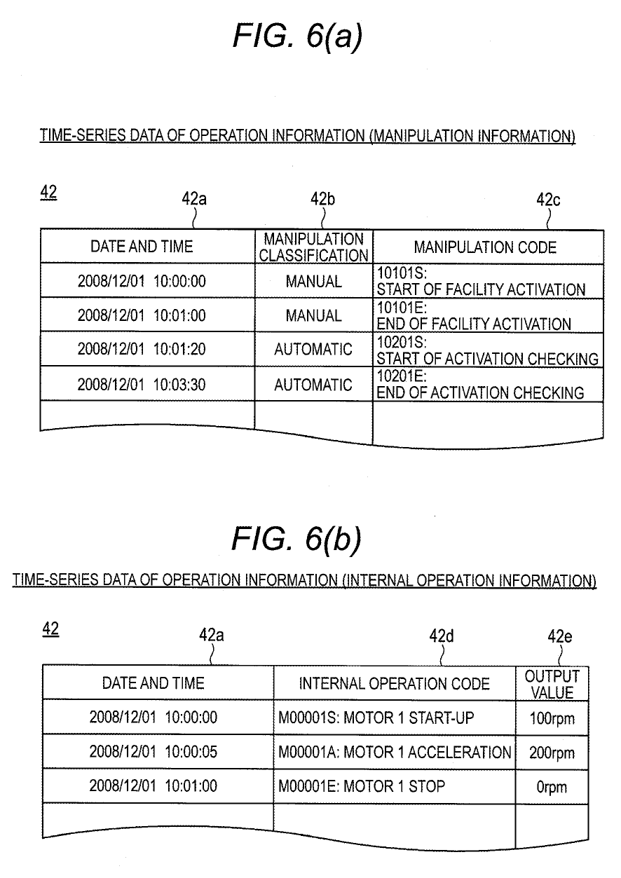

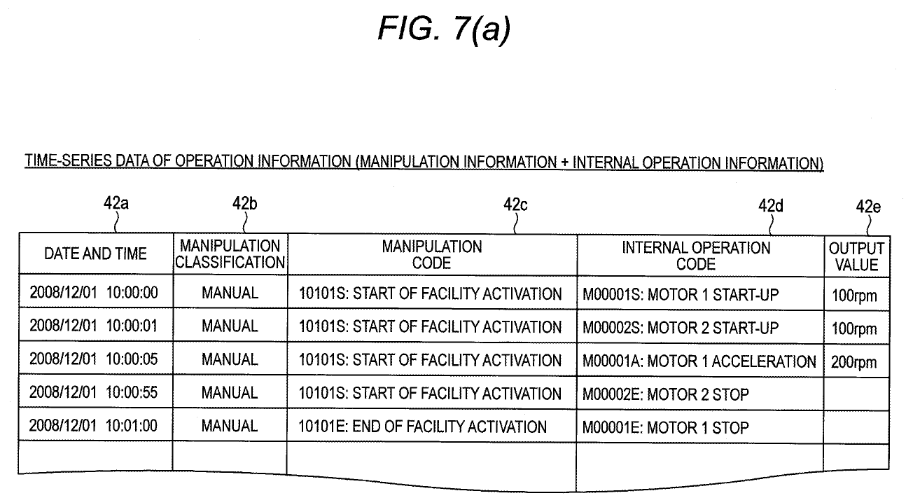

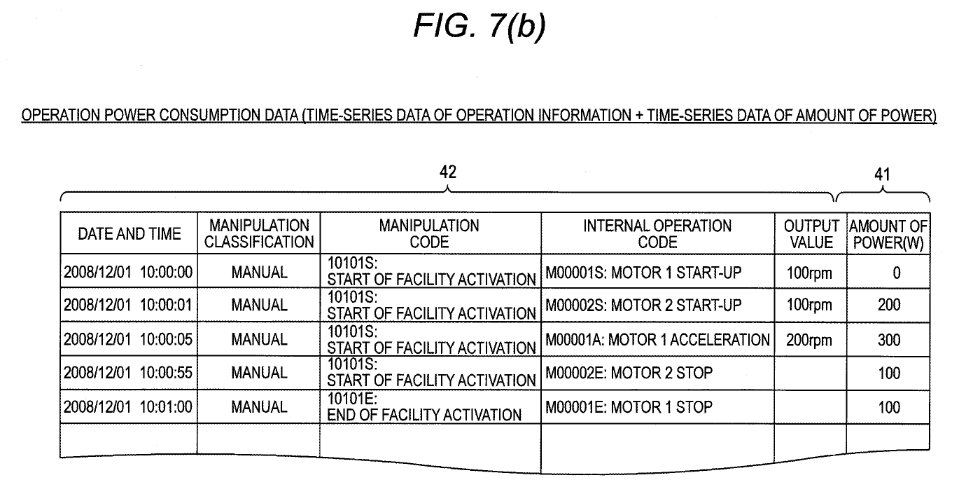

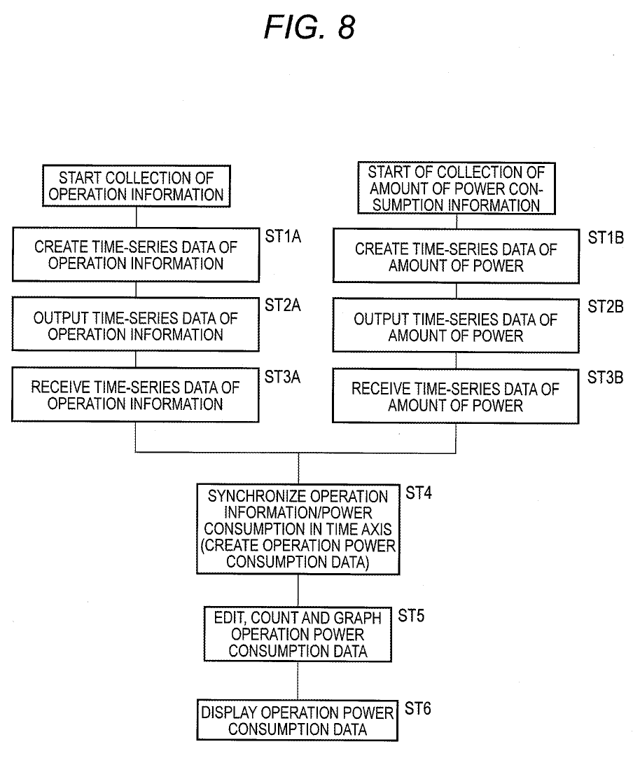

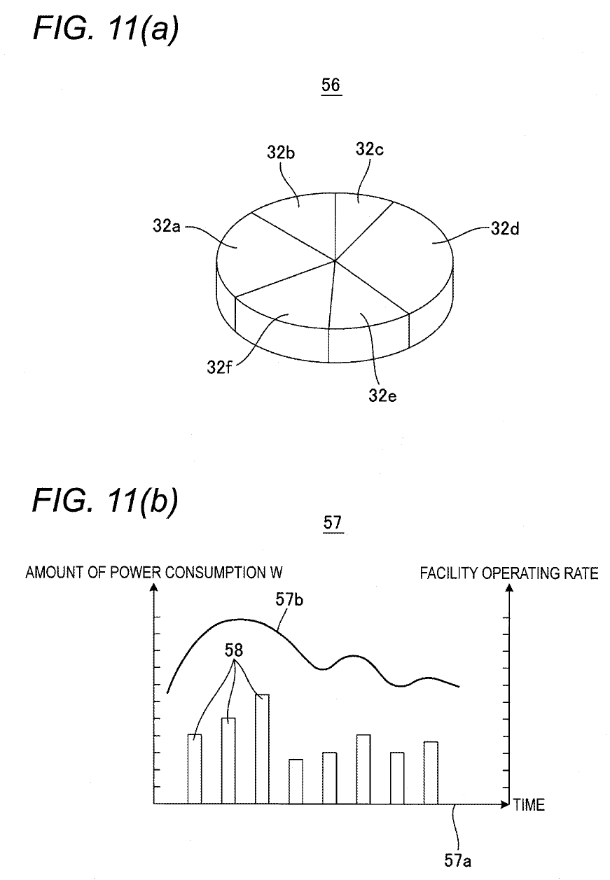

Hereinafter, an embodiment of the invention will be described with reference to the drawings. FIG. 1 shows an explanation diagram illustrating a configuration of a component mounting system of an embodiment 1 of the invention, FIG. 2 shows a block diagram illustrating a configuration of a device for mounting component of the embodiment 1 of the invention, FIG. 3 shows a block diagram illustrating a configuration of a power monitoring process unit in the device for mounting component of the embodiment 1 of the invention, FIGS. 4 and 5 show an explanatory diagram illustrating a data configuration of operation information output from the power monitoring process unit of the embodiment 1 of the invention, FIGS. 6 and 7 show an explanatory diagram illustrating an output example of the operation information output from the power monitoring process unit of the embodiment 1 of the invention, FIG. 8 shows a process flow diagram illustrating a power monitoring method of the embodiment 1 of the invention, FIGS. 9 to 11 show an explanatory diagram illustrating a display example of operation power consumption data output from the power monitoring process unit of the embodiment 1 of the invention, and FIG. 12 shows an explanatory diagram illustrating a configuration of a component mounting system of the embodiment 1 of the invention.

First, a configuration of a component mounting line 1 will be described with reference to FIG. 1. A component mounting line 1 has a function of manufacturing a mounting board on which an electronic component is mounted, and has a configuration in which from an upstream side (a left side in FIG. 1), devices including a loader M1, a printing machine M2, a component mounting machine M3, an inspecting machine M4, a reflow oven M5, and an unloader M6 are linearly connected in a board conveying direction (X direction). Each of the devices is a device for mounting a component which constitutes the component mounting line 1 that mounts a component on a board and manufactures a component mounting board. These devices for mounting component are connected to a management computer 3 via a LAN line 2, are driven by power supplied from a power line 4, and execute a predetermined working. The management computer 3 has a function of controlling overall workings performed by each facility and in this embodiment, is used for displaying and analyzing operation power consumption data output from a power monitoring unit 16 described later.

The loader M1 located at the uppermost stream is a board supplying device, and the board supplied from the loader M1 is conveyed into the printing machine M2 and the printing of a cream solder that is a component bonding paste is performed therein. The board after the printing is conveyed to a component mounting machine M3 and the mounting of component such as a semiconductor chip is performed therein. The board after mounting the component is an object to be inspected by the inspecting machine M4. The board after the inspection is conveyed to the reflow oven M5, and the board is heated to heat the cream solder and thereby the electronic component is solder-bonded to the board. The board after the solder-bonding is recovered to the unloader M6 that is a board recovery device.

Hereinafter, a configuration of the printing machine M2, the component mounting machine M3, the inspecting machine M4, and the reflow oven M5 used in the component mounting line 1 will be described with reference to FIG. 2. The printing machine M2, the component mounting machine M3, the inspecting machine M4, and the reflow oven M5 include an actuating section 10 for executing a predetermined working process that is assigned to each of the devices. Each of the actuating sections 10 is configured by an element actuating section mechanism such as an electric actuator and an electric heating device that is an element constituting a working process function given to the device. For example, the component mounting machine M3, which mounts a component on a board, includes an actuating section 10. The actuating section 10 includes an electric actuator such as a motor 1 that operates a conveyor for conveying a board, and motors 2, 3, and 4 that operate a mounting head for conveying and mounting a component in X, Y and Z directions, as an element actuating section 10a. In addition, the reflow oven M5, which melts a cream solder and solder-bonds the component on the board, includes an actuating section 10 including an electric heating device for pre-heating and heating to heat the board, as an element actuating section 10a. Similarly, the printing machine M2 and the inspecting machine M4 include an element actuating section 10a that is an element constituting a working process function given to them, respectively.

Specifically, in an example illustrating this embodiment of the invention, these element actuating sections 10a are configured to be included in each of the printing machine M2 as a printing section that prints a component bonding paste on the board, the component mounting machine M3 as a component mounting section that mounts a component on the board on which the paste is printed, the inspecting machine M4 as an inspecting section that images the board before and after mounting the component and executes a predetermined inspection, and the reflow oven M5 as a reflow section that heats the board after mounting the component and solder-bonds the component to the board.

Next, a configuration of a drive/control system for causing the actuating section 10 in each device to execute a predetermined working process will be described. A control section 11 is CPU, and controls each section described below, and thereby constitutes the actuating section 10 perform a working process. A storage section 12 stores various programs and data necessary for the control by the control section 11. The manipulation/input section 13 is an input means such as a keyboard and a mouse, and performs an indication input such as a command and data for giving a manipulation indication to the corresponding device. The display section 14 is a display device such as a liquid crystal panel, and performs a display of a guide screen for an input manipulation by the manipulation/input section, and various alarms or notifications or the like at the time of operating the device, and further a display of data output by a power monitoring process unit 16. A driving section 15 is configured by various drivers for bringing the element actuating sections 10a, which constitute the actuating section 10, into operation, and brings the element actuating sections 10a into operation based on a control command from the control section 11 by power supplied from the power line 4 via a power supply line 4a. The power monitoring process unit 16 has a function of monitoring an amount of power that is supplied to the driving section 15 via the power supply line 4a and is consumed by the respective element actuating sections 10a by correlation with an operation state of the corresponding device. A communication section 17 is connected to the LAN line 2 and performs a signal transmission to and a signal reception from the management computer 3 or another device via the LAN line 2.

A configuration and a function of the power monitoring process unit 16 (power monitoring device) will be described with reference to FIG. 3. The power monitoring process unit 16 includes an operation information collecting section 23, a power measuring section 24, a synchronous output section 25, and display processing section 26. The operation information collecting section 23 collects in time-series operation information representing an operation state of a corresponding device and performs a process of creating time-series data of the operation information. That is, the operation information collecting section 23 constantly receives a control signal output as necessary from the control section 11 as individual operation information, and outputs the received information as time-series data 42 of the operation information by correlating a reception timing with a time on a time axis of a built-in time-measuring timer 23a.

The power measuring section 24 measures in time-series an amount of power consumption representing an amount of power consumed in a corresponding device, and performs a process of creating time-series data 41 of the amount of power. That is, the power measuring section 24 includes a time-measuring timer 24a and power meter 24b that are built-in, and constantly measures an amount of power supplied from the power line 4 to the driving section 15 via the power supply line 4a by the power meter 24b and then outputs the measured value as time-series data 41 of the amount of power by correlating the measured value and a time on a time axis of the time-measuring timer 24a. As a data format of the time-series data 41 of the amount of power, either graphic data 41a representing change with the passage of time of the amount of power consumption as a form of a graph 41c, or table-type data 41b that is a type of correlating an amount of power 41e with data and time 41d may be possible.

The synchronous output section 25 has a function of outputting the time-series data 42 of the operation information and the time-series data 41 of the amount of power as operation power consumption data by synchronizing the respective time axes in time-series with each other. The synchronous output section 25 has a unique built-in time-measuring timer 25a, and correlates time axes of the time-measuring timer 23a and the time-measuring timer 24a and a time axis of the time-measuring timer 25a and thereby performs a process of synchronizing the time-series data 42 of the operation information and the time-series data 41 of the amount of power with the time axis of the time-measuring timer 25a. That is, the synchronous output section 25 has a unique time axis and synchronizes the respective time axes in time-series of the time-series data 42 of the operation information and the time-series data 41 of the amount of power with the unique time axis of the synchronous output section 25. The display processing section 26 performs a process of displaying the output operation power consumption data on a display device provided to the display section 14 or the management computer 3.

In addition, in the above-described configuration, the operation information collecting section 23, the power measuring section 24, and the synchronous output section 25 have the individual built-in time-measuring timer 23a, 24a, and 25a, respectively, but in an actual configuration, it is not necessarily necessary to have a dedicated time-measuring timer individually. For example, a time-measuring timer common to the entire power monitoring process unit 16 may be provided, and the operation information collecting section 23, the power measuring section 24, and the synchronous output section 25 may refer to the common time-measuring timer.

Here, the significance and a data configuration of the operation information will be described with reference to FIGS. 4 and 5. As described above, the operation information represents an operation state of a corresponding device, and in this embodiment, the operation information is configured from two viewpoints, that is, manipulation information representing that when considering the corresponding device on the whole, which state the corresponding device is in a manipulation sequence for executing a predetermined working, and internal operation information representing which operation state the element actuating sections 10a constituting the actuating section 10 built in the device are in, individually.

First, FIG. 4 shows an example where the manipulation information is configured by arranging in parallel the above-described manipulation information and internal operation information, individually. That is, as shown in FIG. 4, in this case, operation information 30 is displayed in a form where both manipulation information 31 and internal operation information 34 are arranged in parallel. The manipulation information 31 is information representing in a corresponding device, which process is executed among a plurality of working processes 32 specified in a predetermined sequence for executing a predetermined working function. In the example shown in FIG. 4, there is shown an example where working processes 32a, 32b, 32c, 32d, 32e, and 32f corresponding to a facility actuation, an actuation checking, a nozzle checking, a feeder teaching, a board conveying, and a component mounting, respectively, or the like are specified as a plurality of working processes 32. The manipulation information 31 is configured by being combined with an execution state 33 representing which working process is executed among these working processes. In other words, the manipulation information 31 is operation information for each working process, which represents the operation state of the device for each working process.

The internal operation information 34 is configured by combining element actuating section data 35 that lists-up the element actuating sections 10a provided to the actuating section 10 of a corresponding device, on-off information 36, and power index information 37. The on-off information 36 represents whether or not each of the element actuating sections 10a is actuated (on-off state), and the power index information 37 is an index for estimating an amount of power consumed by a corresponding element actuating section 10a in a case where the element actuating section 10a is actuated. In a case where the element actuating section 10a is an electric motor, as the power index information 37, a number of rotations (rpm) of the motor or an angular acceleration may be used as it is as the power index information 37, or a moving speed or an acceleration of an object to be driven, which can be correlated with the number of rotations of the motor or the angular acceleration, may be used as the power index information 37. In addition, in a case where the element actuating section 10a is an electric heating device such as a heater, an output of the heater may be used as the power index information 37.

In the example shown in FIG. 4, a motor 1 for driving a conveyor provided to a board conveying mechanism of the component mounting machine M3, a motor 2 (X-axis of head) for driving a mounting head provided to a component mounting mechanism, a motor 3 (Y-axis of head), a motor 4 (Z-axis of head) or the like are listed-up as element actuating section data 35a, 35b, 35c and 35d. In addition, it is not necessarily necessary to include both the on-off information 36 and the power index information 37 in the operation information 30, and either of them may be included. That is, in this embodiment, the operation information 30 includes at least one of the on-off information 36 representing on-off state of the element actuating section 10a that consumes power in the device for mounting a component and is actuated and the power index information 37 that is an index an amount of power consumed by the element actuating section.

In a case where as such operation information 30, the manipulation information 31 and the internal operation information 34 are treated as individual data, the time-series data 42 of the operation information corresponds to the manipulation information 31 and the internal operation information 34, respectively, and is output from the operation information collecting section 23, as data with a form as shown in FIGS. 6(a) and 6(b). That is, in the time-series data 42 of the operation information corresponding to the manipulation information 31, as shown in FIG. 6(a), in regard to each working process 32 (here, only working processes 32a and 32b corresponding to the facility actuation and the activation checking are shown), each item of a manipulation code 42c, a manipulation classification 42b, and date and time 42a is combined and is output. The manipulation code 42c is data that is output from the control section 11 of a corresponding device and represents a start and an end of respective working processes, and the manipulation classification 42b represents whether the manipulation is manual or automatic. The date and time 42a represents a timing when each manipulation code 42c is output from the control section 11.

In addition, in the time-series data 42 of the operation information corresponding to the internal operation information 34, as shown in FIG. 6(b), in regard to each of the element actuating sections 10a (here, only the motor 1 is shown), an internal operation code 42d, the date and time 42a, and an output value 42e are combined and are output. The internal operation code 42d is data that is output from the control section 11 of a corresponding device and represents an operation state such as a start-up, acceleration, and a stop of a corresponding motor, and the date and time 42a represents a timing when the internal operation code 42d is output from the control section 11. The output value 42e has a meaning as the power index information 37 serving as an index of an amount of power consumption of the element actuating section data 35 in a corresponding operation state. The time-series data 42 of the operation information created as described above, and the time-series data 41 of the amount of power shown in FIG. 3 are compared to each other, and thereby it is possible to accurately grasp a relationship between an operation state and an amount of power consumption in a corresponding device.

In addition, as shown in FIG. 5, the internal operation information 34 shown in FIG. 4 may be linked to each working process 32 in advance. That is, the element actuating section 10a, which is in an operation state when a corresponding process is executed for each working process 32, is specified, and each working process 32 and the element actuating section data 35 are linked on the data in advance. In an example shown in FIG. 5, element actuating section data 35a, 35b, 35c, and 35d corresponding to a motor 1 for driving a conveyor, a motor 2 for driving a mounting head, a motor 3, and a motor 4, respectively, are linked to a working process 32a corresponding to “facility actuation” in advance. Similarly to this, the element actuating section data 35 corresponding to the element actuating section 10a that is actuated in a corresponding working process is also linked to subsequent working processes 32b, 32c, . . . .

FIG. 7(a) shows a configuration example of the time-series data 42 of the operation information in the operation information defined by the data configuration shown in FIG. 5. That is, here, the date and time 42a, the manipulation classification 42b, the manipulation code 42c, the internal operation code 42d, and the output value 42e are combined in one piece of time-series data 42 of the operation information. The time-series data 42 of the operation information with the configuration described above and the time-series data 41 of the amount of power shown in FIG. 3 are compared to each other, and thereby it is possible to clearly grasp a relationship between an operation state and an amount of power consumption of each of the element actuating sections 10a in a specific working process 32. In addition, as shown in FIG. 7(b), the time-series data 42 of the operation information shown in FIG. 7(a) and the time-series data 41 of the amount of power shown in FIG. 3 may be directly correlated in a single data set, and may be created as operation power consumption data.

Next, a process sequence of a power monitoring method executed by the power monitoring process unit 16 will be described with reference to FIG. 8. The power monitoring method is executed for the purpose of monitoring power consumed in the printing machine M2, the component mounting machine M3, the inspecting machine M4, and the reflow oven M5 that are devices for mounting component, which constitute the component mounting line 1. First, when activation manipulation for activating each device is performed, the power monitoring process unit 16 starts a collection of the operation information and power consumption information immediately. That is, individual operation information (refer to the manipulation code 42c, the internal operation code 42d shown in FIG. 6) output from the control section 11 is continuously received by the operation information collecting section 23, a timing when the operation information is received is correlated with a time axis and is collected in time-series, and creates time-series data of the operation information (ST1A) (operation information collecting process). At the same time, the power measuring section 24 measures an amount of power consumption in time-series by the power meter 24b and creates time-series data of the amount of power (ST1B) (power measuring process).

Subsequently, the time-series data 42 of the operation information is output from the operation information collecting section 23 (ST2A), and the time-series data 41 of the amount of power is output from the power measuring section 24 (ST2B). The output time-series data 42 of the operation information and the time-series data 41 of the amount of power are received by the synchronous output section 25, respectively (ST3A, ST3B). Subsequently, the synchronization of the operation information/power consumption in time axes is performed by the synchronous output section 25 (ST4). Therefore, operation power consumption data in which the time-series data of the operation information and the time-series data of the amount of power are combined is created. That is, in ST4, the time-series data of the operation information and the time-series data of the amount of power are output by synchronizing respective time axes in time-series with each other (synchronous output process).

Subsequently, the created operation power consumption data is edited, counted and graphed (ST5). This process may be performed by the display processing section 26 built in the power monitoring process unit 16, or may be performed by using a data processing function provided in the management computer 3. Subsequently, the operation power consumption data that is edited, counted and graphed is displayed (ST6). Display of this data may be performed by the display section 14 provided to each device, or may be performed by a display device provided in the management computer 3. Subsequently, the operation power consumption data displayed as described is analyzed by a management technician of the component mounting line 1 and an analytical working is executed for the purpose of decreasing the amount of power consumption. In addition, details of the analytical working will be described in embodiment 2 described later.

Next, a display example of the operation power consumption data will be described with reference to FIGS. 9, 10 and 11. First, a display screen 51 shown in FIG. 9(a) shows a variation with the passage of time of the power consumption for each working process 32. That is, here, individual working processes 32 (working processes 32a, 32b, 32c, . . . ), which are sequentially executed in regard to the device operation state, are arranged in time-series on a time axis 51a, a graph 51b showing a timing variation of the amount of power consumed in a corresponding device during that time is displayed in synchronization with the time axis 51a. In this display screen, the individual working processes 32a, 32b, 32c, . . . that are arranged in time-series on the time axis 51a correspond to the time-series data 42 of the operation information, and the graph 51b displayed by synchronizing the amount of power consumption with the time axis 51a corresponds to the time-series data 41 of the amount of power. That is, in the above-described display example, the time-series data 42 of the operation information and the time-series data 41 of the amount of power are displayed on the display screen by synchronizing respective time axes in time-series with each other. By performing the display as described above, it is possible to easily grasp a relationship between the variation with the passage of time in the amount of power consumption and the working process.

In addition, as shown in FIG. 9(b), a result of individually calculating the temporal average value of power consumption consumed in each working process 32 for each working process 32 may be displayed with a bar graph 51c on the time axis 51a. In a case where it is desired to roughly grasp the variation of the power consumption for each working process 32, an intuitive understanding is made to be easy by such a display method. In addition, as shown in FIG. 9(C), each working process 32 may be arranged in the order of magnitude of the temporal average value of the power consumption. In addition, in a case where it is desired to analyze the variation in the amount of power consumption from a further detailed viewpoint, an amount of power consumption for each element actuating section data 35 may be calculated to be displayed, instead of the working process 32 on FIG. 9.

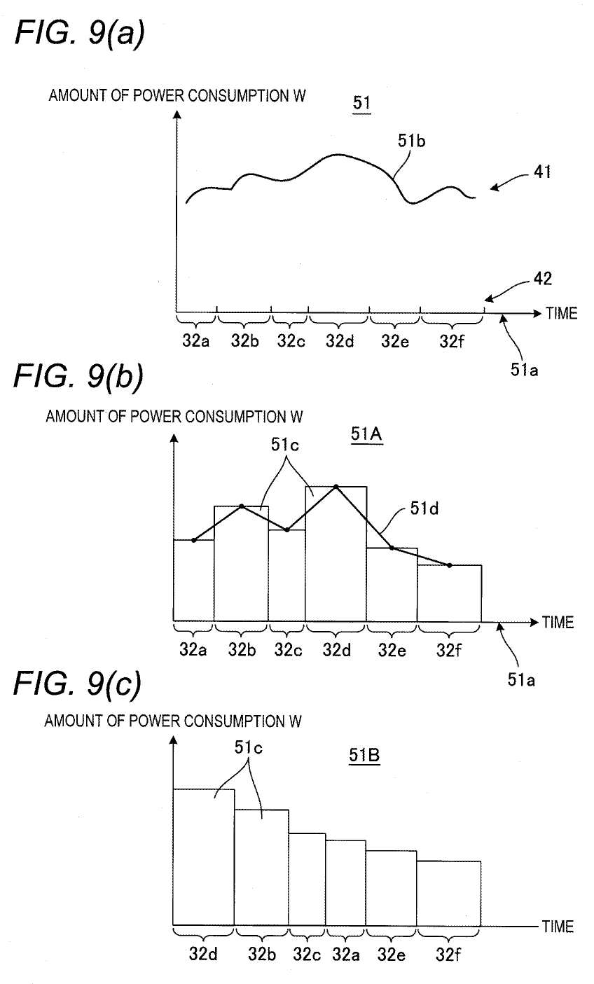

A display screen 52 shown in FIG. 10 illustrates an example where only time-series data 41 of an amount of power is displayed on an initial screen, and desired operation information is displayed at an arbitrary point in time by the manipulation of a data analyzer. That is, in regard to the display screen 52, only the time-series data 41 of the amount of power (here, a graph 52b representing an amount of power consumption at each time of a time axis 52a) is displayed in advance on the display screen 52. In this state, when the data analyzer indicates an arbitrary point in time of the time axis 52a by a pointer 52c and performs a predetermined indication manipulation such as a click manipulation by a mouse, a display window 53 showing operation information at the point in time is automatically displayed on the screen. In addition, the indication manipulation may be performed by indicating an arbitrary time on the graph 52b representing an amount of power consumption instead of indicating the time axis 52a.

In the display window 53, actuating section display frames 53b, 53c, 53d, . . . displaying an element actuating section 10a that is being actuated are displayed together with a process display frame 53a displaying a working process that is being executed at a corresponding point in time. In an example shown in FIG. 10, in the process display frame 53a, “component mounting” is displayed and this indicates that component mounting is being executed as a working process, and in the actuating section display frames 53b, 53c, 53d . . . , “motor 1”, “motor 2”, “motor 3”, . . . are displayed and this indicates that these motors are being actuated. Such a display process is executed by a predetermined data processing performed by the display processing section 26 or the management computer 3, on the basis of operation power consumption data created by the synchronous output section 25.

That is, in the example shown in FIG. 10, in regard to the display screen displaying the time-series data 42 of the amount of power, when a specific point in time of the time axis 52a in time-series of the time-series data 42 of the amount of power is indicated, the operation information corresponding to the specific point in time is displayed on the display screen. Furthermore, display windows 54b, 54c, and 54d that show more detailed time-series data 41 of the amount of power that is correlated to the motor 1, motor 2, motor 3, . . . with graphs 55a, 55b and 55c may be overlapped and displayed on the same display screen, by click-manipulating the operating section display frames 53b, 53c, 53d, . . . on the screen. Here, the graphs 55a, 55b, and 55c are graphs (graphs in a predetermined span (for example, in a span between adjacent scale marks) before and after a specific point in time in a designated time axis 52a) that show in time-series variation in a rotation speed (number of rotations per unit time) of each motor. As used data, time-series variation data of an output, which is correlated with the power consumption for each motor (data corresponding to the above-described power index information 37), may be used, other than the above-described data. In addition, it does not matter if in each of the motors, a motor with the largest power consumption is specified, and the display is performed to allow the specified motor to be understood. For example, it is considered that the color of the actuating section display frames 53b, 53c, and 53d that correspond to the specified motor in the display window 53 of FIG. 10 is varied and blinks. In addition, as a “motor with the largest power consumption”, for example, there is a motor with the largest area (corresponding to power consumption) between time axes of a graph of a motor rotation speed displayed in time-series.

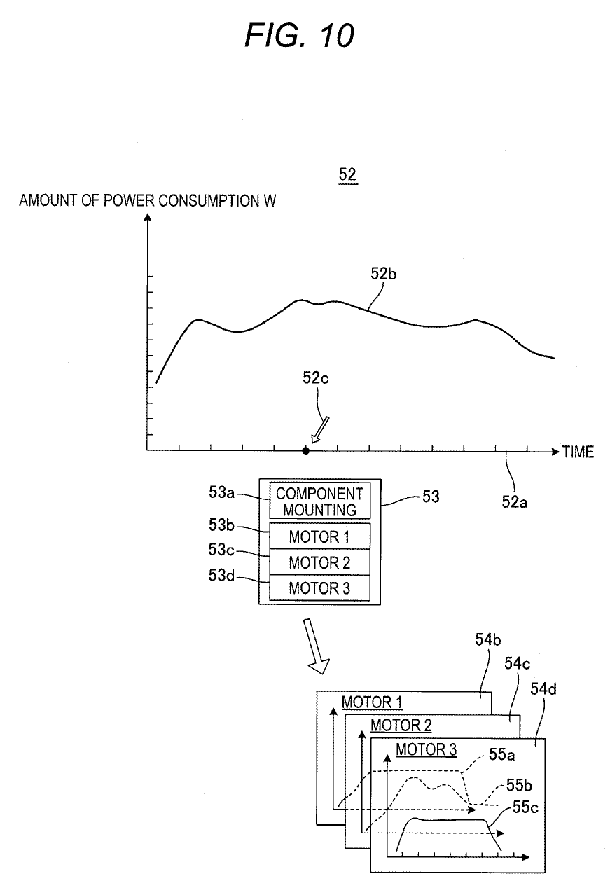

In addition, FIG. 11 shows an example of a screen that can be displayed based on the operation power consumption data output by the power monitoring process unit 16, other than the above-described screen. A display screen 56 shown in FIG. 11(a) illustrates an example where details of the power consumption in any monitoring interval (for example, one day) for each working process 32 is displayed with a circle-graph for an easy intuitive grasp. In addition, a display screen 57 shown in FIG. 11(b) illustrates an example where a graph 57b showing variation with the passage of time of the amount of power consumption and a bar graph 58 showing a temporal facility operating rate (derived from time-series data 42 of the operation information) of a corresponding device are overlapped on a common time axis 57a and are displayed. Therefore, it is possible to easily grasp a relationship between the facility operating rate and the amount of power consumption. In addition, in a graph in FIG. 11, it does not matter if the working process 32 is designated and a ratio of the amount of power consumption for each element actuating section (motor) 10a in each designated working process 32 is displayed. Here, display of “the ratio of the amount of power consumption for each element actuating section (motor) 10a” means that for example, an area between time axes of a graph of the number of rotations of a motor of each motor in a corresponding working process 32 is calculated as an amount of power consumption and a ratio of the area is displayed.

In addition, in regard to the display screen displayed based on the operation power consumption data, various variations are possible. That is, as long as this is based on data that can be derived by synchronizing the time-series data of the operation information and the time-series data of the amount of power, a display example other than the display examples shown in FIGS. 9 to 11 may be possible. Furthermore, in the above-described example, the amount of power consumption measured by the power measuring section 24 in the power measuring process is output without change as the amount of power and is displayed, but an amount of carbon dioxide emitted in the process of generating power, which corresponds to the amount of power consumption, may be substituted for the amount of power consumption to be displayed. Here, it is additionally stated that the amount of the carbon dioxide substituted for the amount of power consumption is an example of the “amount of power consumption” described in claim 1. A conversion equation for converting the amount of power to an amount of carbon dioxide emissions is used for the substitution. That is, in this case, time-series data of the amount of carbon dioxide emissions, which is obtained by converting the amount of power consumption measured in the power measuring process illustrated in FIG. 8 to the amount of carbon dioxide emissions, is created and in the synchronous output process, the time-series data 42 of the operation information and the time-series data of the amount of carbon dioxide emissions is output with the respective time axes in time-series synchronized with each other.

First, in the component mounting line 1 shown in FIG. 1, the power monitoring process unit 16 is built in each of the printing machine M2, the component mounting machine M3, the inspecting machine M4, and the reflow oven M5 that are device for mounting component constituting the component mounting line 1, and the time-series data of the operation information and the time-series data of the amount of power of a corresponding device are created individually in each device, but the invention is not limited to this type and the power monitoring process unit 16 may be configured independently from each device. Such a configuration example will be described with reference to FIG. 12.

A component mounting line 1A in FIG. 12 has a configuration in which devices for mounting component including loader M1, a printing machine M2, a component mounting machine M3, an inspecting machine M4, a reflow oven M5, and an unloader M6 are linearly connected in a board conveying direction (X direction), similar to the component mounting line 1 shown in FIG. 1. All of these devices for mounting component are connected to a management computer 3 via a LAN line 2, are driven by power supplied from a power line 4, and execute a predetermined working.

A power monitoring process unit 16A that includes a plurality of process channels having the same function as that of the power monitoring process unit 16 is provided to the power line 4. To each of the channels of the power monitoring process unit 16A, the printing machine M2, the component mounting machine M3, the inspecting machine M4, and the reflow oven M5 are allocated as an objective device to be monitored, and the power monitoring process unit 16A as the power monitoring device collectively executes the above-described power monitoring processes with respect to the objective device to be monitored. Therefore, the power monitoring process unit 16 configured as shown in FIG. 2 is excluded from the printing machine M2 to the reflow oven M5.

That is, the power monitoring process unit 16A collects in time-series individual operation information supplied from a control section 11 of each device by the operation information collecting section 23 and creates time-series data 42 of the operation information, and measures in time-series an amount of power consumption of each device by the power measuring section 24 and creates time-series data 41 of the amount of power consumption. The individual operation information output from the control section 11 of each device may be transmitted to the power monitoring process unit 16A via the LAN line 2 or may be transmitted to the power monitoring process unit 16A via the power line 4. Subsequently, the time-series data 42 of the operation information and the time-series data 41 of the amount of power are output as operation power consumption data by the synchronous output section 25 by synchronizing respective time axes in time-series with each other. By such a configuration, the same effect as that by the configuration shown in FIGS. 1 to 3 is obtained.

As described above, in the invention, the time-series data of the operation information created by collecting in time-series the operation information representing a device operation state of the device for mounting component and the time-series data of the amount of power created by measuring in time-series the amount of power consumption representing the amount of power consumed in the device for mounting component are output as the operation power consumption data by synchronizing the respective time axes in time-series with each other. Therefore, it is possible to secondarily create data with a form corresponding to various objects by combining information derived from the operation power consumption data, whereby it is possible to utilize the power monitoring result as effective information for decreasing the amount of power consumption.

### Embodiment 2

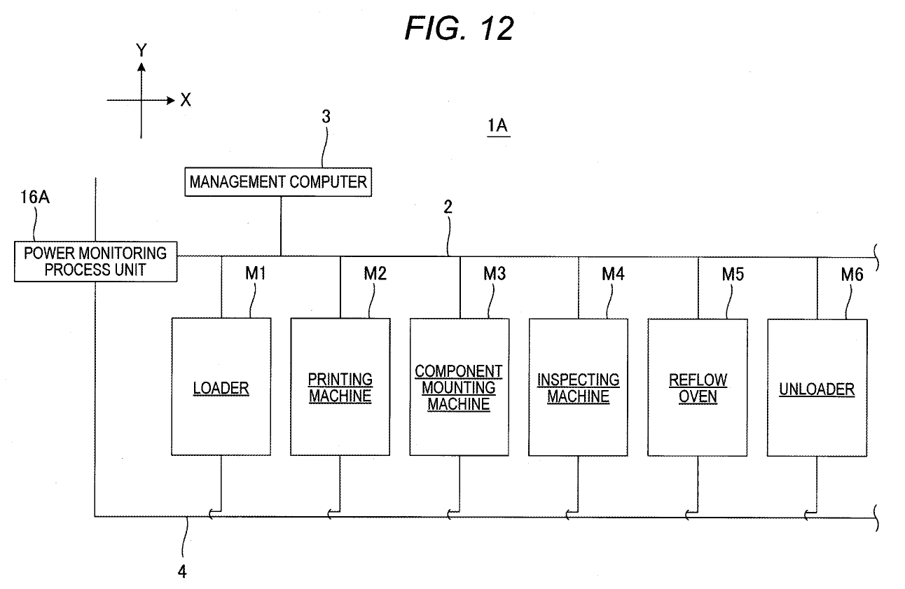

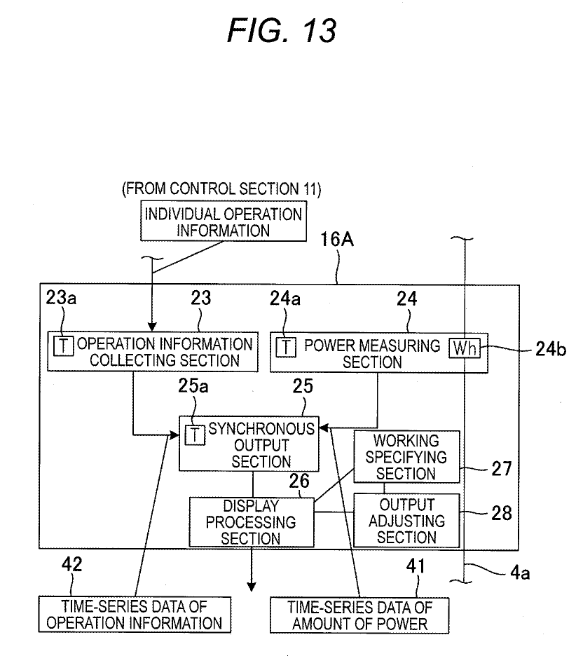

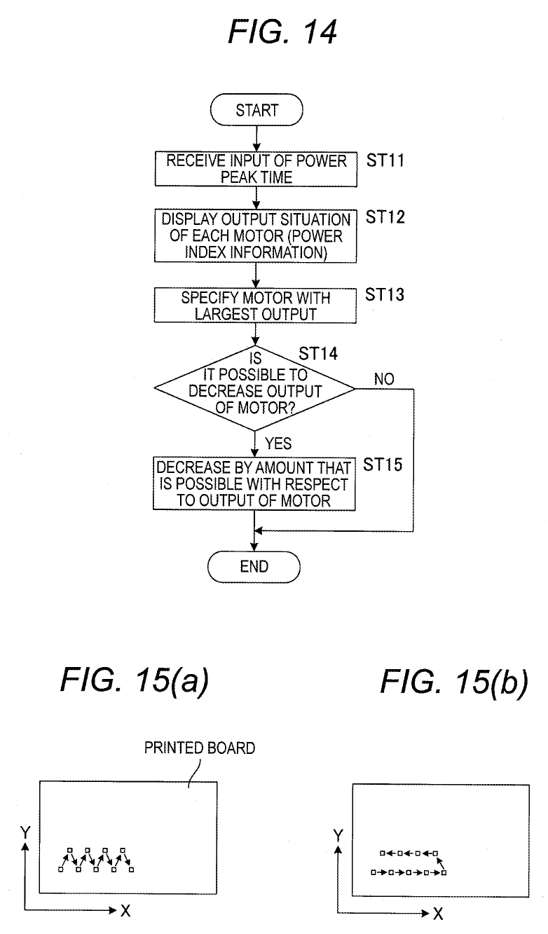

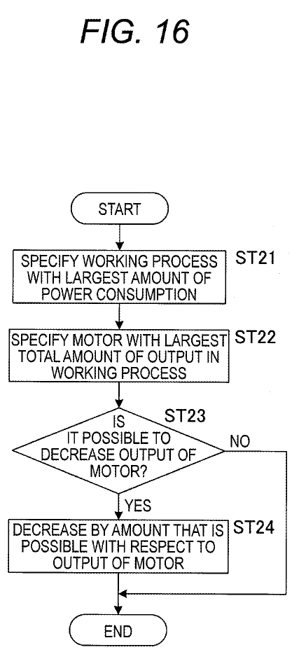

FIG. 13 shows a block diagram illustrating a configuration of a power monitoring process unit in a device for mounting component of an embodiment 2 of the invention, FIG. 14 shows a flow chart illustrating the sequence of adjustment for decreasing an output of an element actuating section, which is the largest source of power consumption at the peak time of power consumption, in regard to a transition graph of the power consumption in FIG. 10, FIGS. 15(a) and 15(b) show diagrams illustrating a specific example of determination at ST14 of FIG. 14, and FIG. 16 shows a flow chart illustrating the sequence of adjustment for decreasing an output of an element actuating section in a working process where the power consumption becomes the largest, in regard to a graph illustrating a ratio of power consumption for each working process in FIG. 11.

First, a configuration and a function of a power monitoring process unit 16A (power monitoring device) of this embodiment will be described with reference to FIG. 13. The power monitoring process unit 16A includes an operation information collecting section 23, a power measuring section 24, a synchronous output section 25, a display processing section 26, a working specifying section 27, and an output adjusting section 28. The operation information collecting section 23 collects in time-series operation information representing a device operation state of a corresponding device and performs a process of creating time-series data of the operation information. That is, the operation information collecting section 23 continuously receives a control signal output as necessary the control section 11 as individual operation information, and outputs the received information as time-series data 42 of the operation information by correlating a reception timing with a time on a time axis of a built-in time-measuring timer 23a.

The power measuring section 24 measures in time-series an amount of power consumption representing an amount of power consumed in a corresponding device, and performs a process of creating time-series data 41 of the amount of power. Specifically, the power measuring section 24 includes a time-measuring timer 24a and power meter 24b that are built-in, and continuously measures an amount of power supplied from the power line 4 to the driving section 15 via the power supply line 4a by the power meter 24b and then outputs the measured value as time-series data 41 of the amount of power by correlating the measured value and a time on a time axis of the time-measuring timer 24a. As a data format of the time-series data 41 of the amount of power, either graphic data 41a representing change with the passage of time of the amount of power consumption as a form of a graph 41c, or table-type data 41b that is a type corresponding to an amount of power 41e with data and time 41d may be possible (see FIG. 3).

The synchronous output section 25 has a function of outputting the time-series data 42 of the operation information and the time-series data 41 of the amount of power as operation power consumption data by synchronizing respective time axes in time-series with each other. The synchronous output section 25 has a unique built-in time-measuring timer 25a, and correlates time axes of the time-measuring timer 23a and the time-measuring timer 24a and a time axis of the time-measuring timer 25a and thereby performs a process of synchronizing the time-series data 42 of the operation information and the time-series data 41 of the amount of power with the time axis of the time-measuring timer 25a. That is, the synchronous output section 25 has a unique time axis and synchronizes the respective time axes in time-series of the time-series data 42 of the operation information and the time-series data 41 of the amount of power with the unique time axis of the synchronous output section 25. The display processing section 26 performs a process of displaying the output operation power consumption data on a display device provided to the display section 14 or the management computer 3 (see FIGS. 1 and 2).

The working specifying section 27 specifies a working process 32 or an element actuating section 10a, which is the largest source of power consumption. The output adjusting section 28 performs, for the element actuating section 10a specified by the working specifying section 27 or an element actuating section 10a that is the largest source of power consumption in the specified working process 32, adjustment to decrease an output of the element actuating section 10a so as to reduce power consumption.

Next, in regard to the transition graph of the power consumption in FIG. 10, the sequence of adjustment for decreasing an output of an element actuating section 10a that is the largest source of power consumption at the peak time of power consumption (method of suppressing the peak power) will be described with reference to FIG. 14. Here, ST11 to ST13 are processes performed by the working specifying section 27, and ST14 and ST15 are processes performed by the output adjusting section 28. First, an input with respect to the peak power point is received (ST11). Subsequently, an output situation (power index information) of each motor is displayed (ST12). Subsequently, a motor with the largest output is specified (ST13). In addition, it does not matter if in ST13, an operator looks at an output situation of each motor displayed on a screen, the operator specifies a motor that is the largest source of the power consumption, a manipulation for inputting the motor by the operator is received, and the working specifying section 27 performs a specification according to the input result.

Next, it is determined whether or not the decrease in the output of the motor is possible (ST14). Based on the determination of the possibility at ST14, a specific example described below may be considered.

a) It is determined whether or not there is no problem in terms of a production efficiency even when a rotation speed of the motor (in the case of the driving motor of X, Y axis direction of the mounting head described in the paragraph 0015, a moving speed of the mounting head) is decreased. For example, it is determined whether or not even when production tact is decreased, it is within a permitted range.

b) It is determined whether or not the number of acceleration and deceleration times of the motor can be reduced. For example, as shown in FIG. 15, in a case where a component is mounted at each component mounting position on a printed board, if it is the mounting sequence of (a), the number of moving times in a Y-axis direction (the number of acceleration and deceleration times) occurs eight times, but if it is the mounting sequence of (b), it is possible to decrease the number of moving times in a Y-axis direction (the number of acceleration and deceleration) to one time (in addition, the number acceleration and deceleration times in an X-direction is eight times without change in all cases).

In a case where in ST14, it is determined that there is no possibility that the output of the motor is decreased, the process ends, but in the case it is determined that there is a possibility, decreases by an amount that is possible with respect to the output of the motor (ST15). In ST15, an indication for the decrease by the determined possible amount is displayed on a display screen. Therefore, an operator can perform a manipulation for decreasing the output of the element actuating section 10a. However, the output adjusting section 28 may transmit a command signal representing the indication to the control section of the device for mounting component. Since the effect of decreasing the output is large, a motor with the largest output is specified and the output of the motor is decreased. However, if there is an effect (specifically, in a case where it is impossible to decrease the output of the motor with the largest output), it does not matter if the output of the motor other than the motor with the largest output is decreased.

Next, in regard to a graph illustrating a ratio of a power consumption for each working process in FIG. 11, the sequence of adjustment for decreasing an output of the element actuating section 10a in the working process 32 where the power consumption becomes the largest (a method of suppressing a total power in a monitoring interval) will be described with reference to FIG. 16. Here, ST21 and ST22 are processes performed by the working specifying section 27, and ST23 and ST24 are processes performed by the output adjusting section 28. First, a working process 32 with the largest amount of power consumption is specified (ST21). Subsequently, a motor with the largest total amount of output in the working process 32 is specified (ST22). In addition, it does not matter if in ST21 and ST22, an operator looks at a ratio of the amount power consumption for each working process and an output situation of each motor, which are displayed on a screen, the operator specifies a working process and a motor, which are the largest source of the power consumption, a manipulation for inputting the motor by the operator is received, and the working specifying section 27 performs a specification according to the input result.

Subsequently, it is determined whether or not the decrease in the output of the motor is possible (ST23). ST23 is the same as ST14 of FIG. 14 described above. In ST23, in a case where in ST23, it is determined that there is no possibility that the output of the motor is decreased, the process ends, but in a case it is determined that there is a possibility, decreases by an amount that is possible with respect to the output of the motor (ST24). ST24 is the same as ST15 of FIG. 14 described above. Since the effect of decreasing the output is large, a motor with the largest output is specified and the output of the motor is decreased. However, if there is an effect (specifically, in a case where it is impossible to decrease the output of the motor with the largest output), it does not matter if the output of the motor other than the motor with the largest output is decreased.

The invention is described in detail or with reference to a specific embodiment, but it should be understood by those skilled in the art that various changes or modifications may be made without departing from the spirit and scope of the invention.

The invention is based on Japanese Patent Application (2008-303969) filed on Nov. 28, 2008, and the content of which is incorporated herein by reference.

### INDUSTRIAL APPLICABILITY

The power monitoring device, the power monitoring method, and the device for mounting component of the invention have an effect of utilizing a monitoring result on the power consumption as effective information for decreasing an amount of power consumption, and are effective in a component mounting field that mounts a component on a board and manufactures a mounting board.

### DESCRIPTION OF REFERENCE SIGNS

1, 1A Component mounting line
2 LAN line
3 Management computer
4 Power line
10 Actuating section
10A Element actuating section
23a, 24a, 25a Time-measuring timer
24b Power meter

1. A power monitoring device configured to monitor power consumed in a device for mounting component, which constitutes a component mounting line, the power monitoring device comprising:
an operation information collecting section configured to collect in time-series operation information representing a device operation state of the device for mounting component and to create time-series data of the operation information;
a power measuring section configured to measure in time-series an amount of power consumption representing an amount of power consumed in the device for mounting component and to create time-series data of the amount of power; and
a synchronous output section configured to output the time-series data of the operation information and the time-series data of the amount of power by synchronizing respective time axes in time-series with each other.

2. The power monitoring device according to claim 1,
wherein the time-series data of the amount of power is data obtained by creating and collecting time-series data of an amount of carbon dioxide emissions converted from the measured amount of power consumption into the amount of carbon dioxide emissions.

3. The power monitoring device according to claim 1,
wherein the operation information includes at least one of on-off information representing an on-off state of an element actuating section configured to operate by consuming power in the device for mounting component and power index information serving as an index of an amount of power consumed by the element actuating section.

4. The power monitoring device according to claim 3, further comprising:
a display section configured to display the time-series data of the operation information and the time-series data of the amount of power by synchronizing respective time axes in time-series with each other such that a relationship between an amount of power consumption at each point in time and power index information of the element actuating section during actuation can be understood.

5. The power monitoring device according to claim 4,
wherein a specific point in time of a time axis in time-series of the time-series data of the amount of power is indicated on a display screen of the display section configured to display the time-series data of the amount of power, thereby the operation information corresponding to the specific point in time is displayed on the display screen.

6. The power monitoring device according to claim 1, further comprising:
a working specifying section configured to specify a working process or an element actuating section, which is a largest source of power consumption.

7. The power monitoring device according to claim 6, further comprising:
an output adjusting section configured to perform, for the element actuating section specified by the working specifying section or an element actuating section that is a largest source of power consumption in the specified working process, adjustment to decrease an output of the element actuating section so as to reduce power consumption.

8. A power monitoring method for monitoring power consumed in a device for mounting component, which constitutes a component mounting line, the power monitoring method comprising:
an operation information collecting process of collecting in time-series operation information representing a device operation state of the device for mounting component and creating time-series data of operation information;
a power measuring process of measuring in time-series an amount of power consumption representing an amount of power consumed in the device for mounting component and creating time-series data of an amount of power; and
a synchronous output process of outputting the time-series data of the operation information and the time-series data of the amount of power by synchronizing respective time axes in time-series with each other.

9. A device for mounting component, which constitutes a component mounting line configured to mount a component on a board and to manufacture a mounting board, the device for mounting component comprising:
an element actuating section configured to operate by consuming power in the device for mounting component; and
a power monitoring device according to claim 1.
